(19) United States
(12) Patent Application Publication
(10) Pub. No.: US 2026/0310800 A1
(43) Pub. Date: Oct. 8, 2026

(54) SOFT WIPE OF DATA STORAGE MEDIA

(71) Applicant: Lenovo Global Technology (United States) Inc., Morrisville, NC (US)

(72) Inventors: Robert J. Kapinos, Durham, NC (US); Igor Stolbikov, Apex, NC (US); Scott Li, Cary, NC (US); Robert James Norton, JR., Raleigh, NC (US)

(21) Appl. No.: 19/169,491

(22) Filed: Apr. 3, 2025

(51) Int. Cl. G06F 21/60; G06F 21/54; G06F 21/78

(52) U.S. Cl. CPC G06F 21/602; G06F 21/54; G06F 21/78

(57) ABSTRACT

One embodiment provides a method, the method including: receiving, at a data storage device, an input instructing that data on the data storage device is to be made inaccessible; and initializing, on the data storage device, a sector mapping and relocation table, wherein the initializing includes mapping all sectors of the sector mapping and relocation table to fake data. Other aspects are claimed and described.

### BACKGROUND

Many devices have one or more data storage devices and some data storage devices can be external to a device. Example data storage devices include, but are not limited to, solid state drives, memory cards, flash drives, and/or the like. Users can write data to the data storage device for storage and later access. Additionally, devices write data to the data storage device as different functions of the device are performed and to allow functions of the device to be performed. Rewritable data storage devices allow a user to overwrite data on the data storage device to put new or different data in the place of previously written data.

### BRIEF SUMMARY

In summary, one aspect provides a method, the method including: receiving, at a data storage device, an input instructing that data on the data storage device is to be made inaccessible; and initializing, on the data storage device, a sector mapping and relocation table, wherein the initializing includes mapping all sectors of the sector mapping and relocation table to fake data.

Another aspect provides a system, the system including: a processor; a memory device that stores instructions that, when executed by the processor, causes the system to: receive, at a data storage device, an input instructing that data on the data storage device is to be made inaccessible; and initialize, on the data storage device, a sector mapping and relocation table, wherein the initializing includes mapping all sectors of the sector mapping and relocation table to fake data.

A further aspect provides a product, the product including: a computer-readable storage device that stores executable code that, when executed by a processor, causes the product to: receive, at a data storage device, an input instructing that data on the data storage device is to be made inaccessible; and initialize, on the data storage device, a sector mapping and relocation table, wherein the initializing includes mapping all sectors of the sector mapping and relocation table to fake data.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 illustrates an example of information handling device circuitry.

FIG. 2 illustrates another example of information handling device circuitry.

FIG. 3 illustrates an example method for initializing a sector mapping and relocation table of a data storage device so as to make the data on the data storage device inaccessible.

FIG. 4 illustrates example illustrations of reading and writing actions after the soft wipe has been performed on a data storage device.

FIG. 5 illustrates an example flowchart of the initialization of the sector mapping and relocation table of a data storage device and subsequent read and write actions.

### DETAILED DESCRIPTION

Once an entity is done utilizing a data storage device, the users or entities may want to make the data on the data storage device inaccessible to other people who may have access to the data storage device. This is commonly referred to as wiping the data storage device. Different entities may have different requirements for wiping the data storage device. For example, some entities may want a more secure and validated data wipe, whereas other entities may be ok with just a simple wipe. To accomplish the most secure wipe in the best manner, it is best that the wipe has no end-user system touch except to turn on the device or to start the wipe, the wipe occurs on the premise of the entity or another secure location, the wipe is cryptographically protected and signed, the initiation of the wipe can be prevented by classes of users, the wipe occurs quickly, and the data storage device is reusable after the wipe without additional steps having to be taken. The conventional solutions do not provide all of these attributes.

One conventional solution is a full disk or device wipe. This process is very time-consuming and slow and requires the system to be on for the length of the wipe. Additionally, it is often impractical to do on premise and has to be taken off premise. Such a wipe cannot be done while the system is in operation because the user performing the wipe has to access the device which cannot occur if it is being wiped. Another conventional solution is to encrypt the disk or device and destroy the keys corresponding to the encryption. This is a fast method that can be done remotely. Additionally, the disk or device has to be pre-encrypted and a user has to manage the keys in order to perform the end stage encryption. A final conventional solution is to do an on-premise seal and then perform the full wipe off premise. Sealing methods are subject to supply chain physical attacks, meaning someone can physically take the disk before the wipe is performed and then have access to the data on the disk. Due to the length of time to perform the wipe, this technique ends up being costly for the entity performing the wipe. Additionally, there has to be a level of trust with the entity performing the wipe that the wipe will actually be performed. Thus, the conventional solutions do not fulfill the desired attributes of a disk wipe.

Accordingly, the described system and method provides a technique for initializing a sector mapping and relocation table of a data storage device so as to make the data on the data storage device inaccessible. As factory initialized, the data storage media may have all the data on the data storage device inaccessible. During use, newly stored data becomes accessible. In response to receiving a later input, the system may restore itself to the factory state and make the data inaccessible. In the later input, the device may require information related to the user providing the input to ensure that the user is a user who is authorized to provide the input to make the data inaccessible. Additionally, in order to make the data inaccessible, the data storage device may need a key that corresponds to a previous initialization of the data storage device.

From its factory or upon receiving the input, the sector mapping and relocation table of the data storage device may be initialized. Conventionally, when the sector mapping and relocation table of the data storage device is initialized, the table is emptied of all entries to make all data accessible. However, in order to make any data that is on the data storage device inaccessible, instead of emptying the sector mapping and relocation table, the system maps all sectors of the table to fake data. Thus, when a read request is made, the read request is directed to the table which then directs it to fake data, whether that fake data is stored in the table or is stored somewhere else that is linked within the table. This makes all the actual or real data on the data storage device inaccessible because there is no way to create a read request that will result in a return of the actual data.

Therefore, a system provides a technical improvement over traditional methods for making data on a data storage device inaccessible. Instead of a full disk wipe which is time-consuming and impractical in some respects, the described system provides a technique that is quick and does not have the same impracticality concerns. Unlike an encryption of the disk, the described system does not require the disk to be pre-encrypted or prepared and also allows for the reuse of the disk after the wipe. Finally, unlike a conventional on-premise seal and off-premise wipe, the described system is not subject to physical attacks, is not costly for the entity performing the wipe, and can be validated by the entity requesting the wipe. Thus, the described system and method provides a technique for making data on a data storage device inaccessible while fulfilling the desired wipe attributes of the wipe having no end-user system touch except to turn on the device or to start the wipe, the wipe occurs on the premise of the entity or another secure location, the wipe can be initiated remotely, the wipe is cryptographically protected and signed, the initiation of the wipe can be prevented by classes of users, the wipe occurs quickly, and the data storage device is reusable after the wipe without additional steps having to be taken.

The illustrated example embodiments will be best understood by reference to the figures. The following description is intended only by way of example, and simply illustrates certain example embodiments.

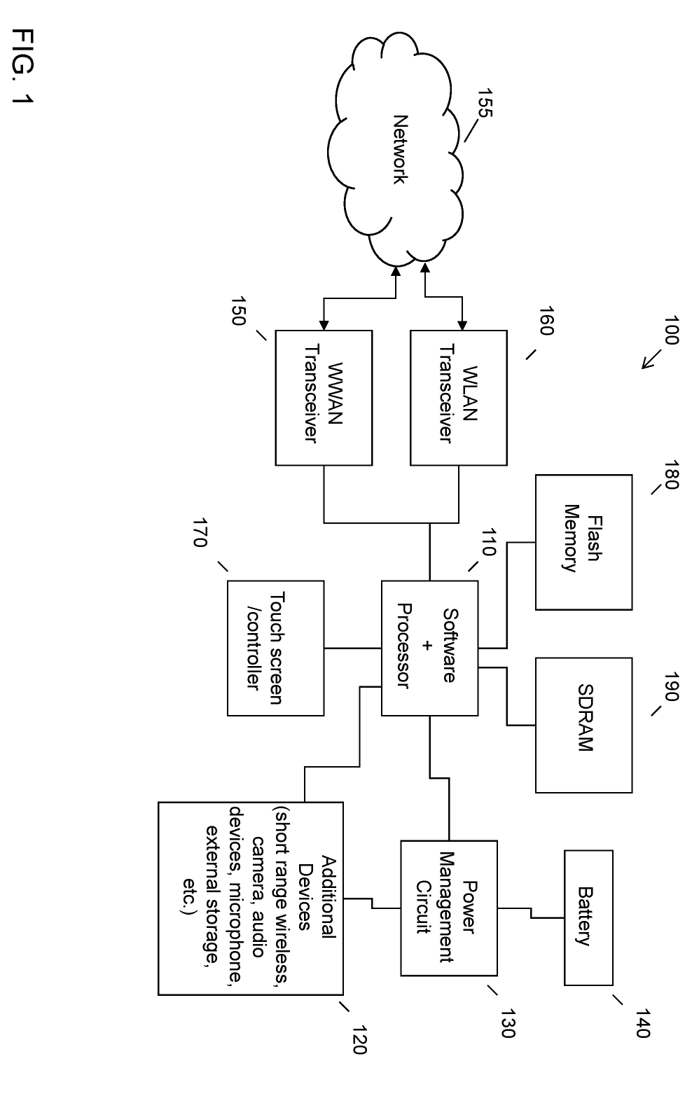

While various other circuits, circuitry or components may be utilized in information handling devices, with regard to smart phone and/or tablet circuitry 100, an example illustrated in FIG. 1 includes a system on a chip design found for example in tablet or other mobile computing platforms. Software and processor(s) are combined in a single chip 110. Processors comprise internal arithmetic units, registers, cache memory, busses, input/output (I/O) ports, etc., as is well known in the art. Internal busses and the like depend on different vendors, but essentially all the peripheral devices (120) may attach to a single chip 110. The circuitry 100 combines the processor, memory control, and I/O controller hub all into a single chip 110. Also, systems 100 of this type do not typically use serial advanced technology attachment (SATA) or peripheral component interconnect (PCI) or low pin count (LPC). Common interfaces, for example, include secure digital input/output (SDIO) and inter-integrated circuit (I2C).

There are power management chip(s) 130, e.g., a battery management unit, BMU, which manage power as supplied, for example, via a rechargeable battery 140, which may be recharged by a connection to a power source (not shown). In at least one design, a single chip, such as 110, is used to supply basic input/output system (BIOS) like functionality and dynamic random-access memory (DRAM) memory.

System 100 typically includes one or more of a wireless wide area network (WWAN) transceiver 150 and a wireless local area network (WLAN) transceiver 160 for connecting to various networks 155 (e.g., telecommunications networks, wireless Internet devices (e.g., access points), cloud networks, remote networks, local networks, etc.). Additionally, devices 120 are commonly included, e.g., a wireless communication device, external storage, camera, microphone, external storage, etc. System 100 often includes a touch screen 170 for data input and display/rendering. System 100 also typically includes various memory devices, for example flash memory 180 and synchronous dynamic random-access memory (SDRAM) 190.

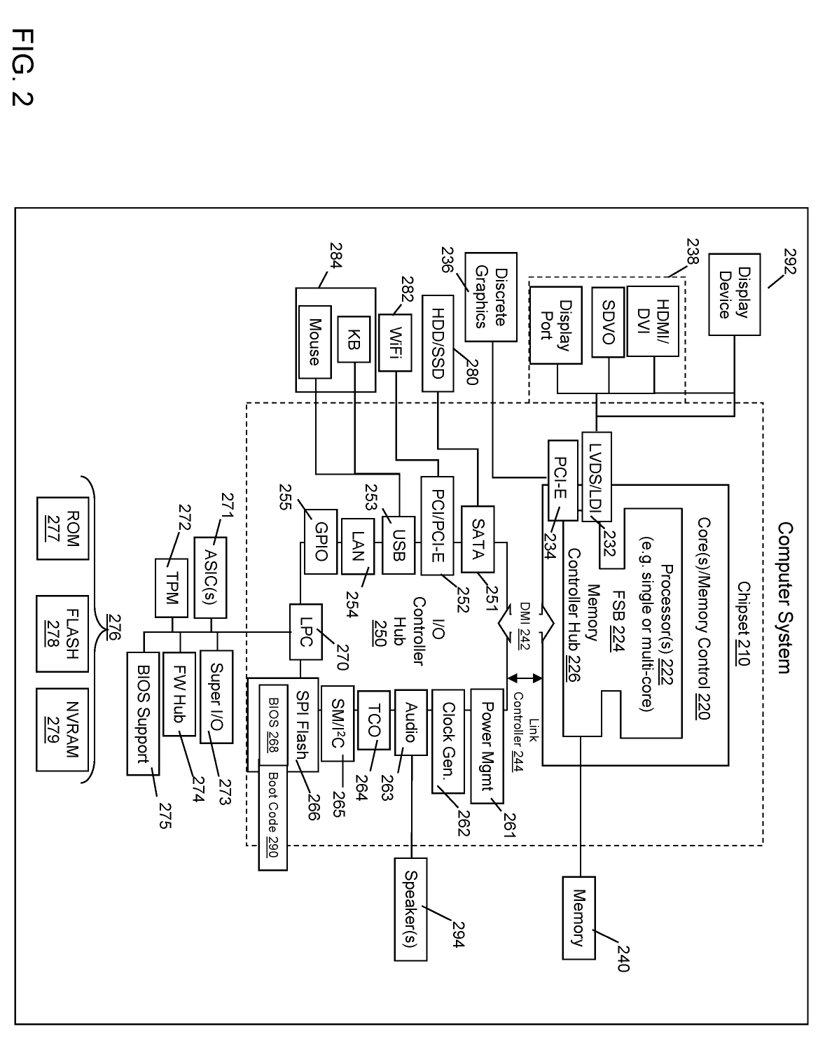

FIG. 2 depicts a block diagram of another example of information handling device circuits, circuitry, or components. The example depicted in FIG. 2 may correspond to computing systems such as personal computers, or other devices. As is apparent from the description herein, embodiments may include other features or only some of the features of the example illustrated in FIG. 2.

The example of FIG. 2 includes a so-called chipset 210 (a group of integrated circuits, or chips, that work together, chipsets) with an architecture that may vary depending on manufacturer. The architecture of the chipset 210 includes a core and memory control group 220 and an I/O controller hub 250 that exchanges information (for example, data, signals, commands, etc.) via a direct management interface (DMI) 242 or a link controller 244. In FIG. 2, the DMI 242 is a chip-to-chip interface (sometimes referred to as being a link between a “northbridge” and a “southbridge”). The core and memory control group 220 include one or more processors 222 (for example, single or multi-core) and a memory controller hub 226 that exchange information via a front side bus (FSB) 224; noting that components of the group 220 may be integrated in a chip that supplants the conventional “northbridge” style architecture. One or more processors 222 comprise internal arithmetic units, registers, cache memory, busses, I/O ports, etc., as is well known in the art.

In FIG. 2, the memory controller hub 226 interfaces with memory 240 (for example, to provide support for a type of random-access memory (RAM) that may be referred to as “system memory” or “memory”). The memory controller hub 226 further includes a low voltage differential signaling (LVDS) interface 232 for a display device 292 (for example, a cathode-ray tube (CRT), a flat panel, touch screen, etc.). A block 238 includes some technologies that may be supported via the low-voltage differential signaling (LVDS) interface 232 (for example, serial digital video, high-definition multimedia interface/digital visual interface (HDMI/DVI), display port). The memory controller hub 226 also includes a PCI-express interface (PCI-E) 234 that may support discrete graphics 236.

In FIG. 2, the I/O hub controller 250 includes a SATA interface 251 (for example, for hard-disc drives (HDDs), solid-state drives (SSDs), etc., 280), a PCI-E interface 252 (for example, for wireless connections 282), a universal serial bus (USB) interface 253 (for example, for devices 284 such as a digitizer, keyboard, mice, cameras, phones, microphones, storage, other connected devices, etc.), a network interface 254 (for example, local area network (LAN)), a general purpose I/O (GPIO) interface 255, a LPC interface 270 (for application-specific integrated circuit (ASICs) 271, a trusted platform module (TPM) 272, a super I/O 273, a firmware hub 274, BIOS support 275 as well as various types of memory 276 such as read-only memory (ROM) 277, Flash 278, and non-volatile RAM (NVRAM) 279), a power management interface 261, a clock generator interface 262, an audio interface 263 (for example, for speakers 294), a time controlled operations (TCO) interface 264, a system management bus interface 265, and serial peripheral interface (SPI) Flash 266, which can include BIOS 268 and boot code 290. The I/O hub controller 250 may include gigabit Ethernet support.

The system, upon power on, may be configured to execute boot code 290 for the BIOS 268, as stored within the SPI Flash 266, and thereafter processes data under the control of one or more operating systems and application software (for example, stored in system memory 240). An operating system may be stored in any of a variety of locations and accessed, for example, according to instructions of the BIOS 268. As described herein, a device may include fewer or more features than shown in the system of FIG. 2.

Information handling device circuitry, as for example outlined in FIG. 1 or FIG. 2, may be used in devices such as tablets, smart phones, personal computer devices generally, and/or electronic devices, which may be devices that utilize data storage media, may be devices used to connect to data storage media to perform the soft wipe of the described system, and/or the like. For example, the circuitry outlined in FIG. 1 may be implemented in a tablet or smart phone embodiment, whereas the circuitry outlined in FIG. 2 may be implemented in a personal computer embodiment.

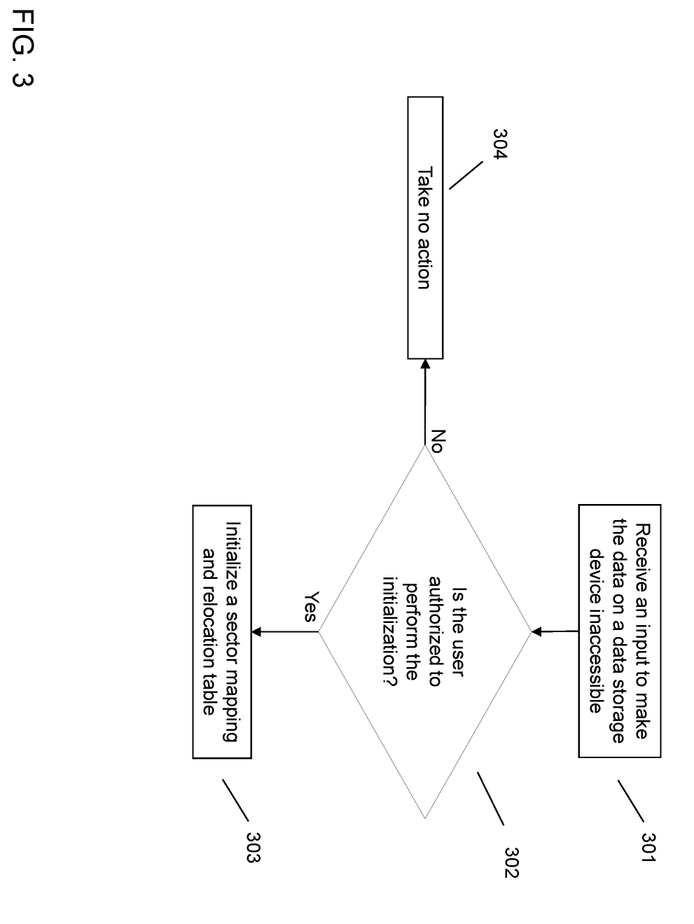

FIG. 3 illustrates an example method for initializing a sector mapping and relocation table of a data storage device so as to make the data on the data storage device inaccessible. The method may be implemented on a system which includes a processor, memory device, output devices (e.g., display device, printer, etc.), input devices (e.g., keyboard, touch screen, mouse, microphones, sensors, biometric scanners, etc.), image capture devices, and/or other components, for example, those discussed in connection with FIG. 1 and/or FIG. 2. While the system may include known hardware and software components and/or hardware and software components developed in the future, the system itself is specifically programmed to perform the functions as described herein to perform a soft wipe of a data storage device. Additionally, the soft wipe system includes modules and features that are unique to the described system.

The soft wipe system may be activated in order to make data on a data storage device inaccessible by initializing the sector mapping and relocation table (SMART) to present fake data when a read request is received. The data storage device is usable after the initialization. When new, real data, is written to the data storage device, the sector(s) of the SMART that corresponds to this new, real data are rewritten to replace the fake data with the new, real data. Thus, when a read request corresponding to this sector is subsequently received, the new, real data is returned as a response to the read request.

Activation of the soft wipe system may be a manual activation of the soft wipe system and/or an automatic activation of the soft wipe system. Manual activation of the system may include a user opening an application associated with the soft wipe system, the user accessing the computing system associated with the soft wipe system, and/or the user otherwise providing input to the soft wipe system. The automatic activation of the soft wipe system may be based upon the detection of a trigger event indicating that the system should be activated. Example trigger events include the first use of the device, detection of the connection of a data storage device to the soft wipe system that performs soft wipes, a user accessing an application that interfaces with the soft wipe system, activation of software or an application utilizing the soft wipe system, and/or the like.

The soft wipe system may be made of multiple systems or modules that communicate together to make up the soft wipe system or may be a single system. The soft wipe system may be a standalone system, may be accessible through other computing devices, and/or a combination thereof. The only requirement is that participating storage device(s) be entirely unable to relay stored data without referring to the sector remapping table to return fake data after a wipe. For example, the soft wipe system may be a standalone system that can be accessed by a user and/or may be or provide an application that is accessible by a user on another computing device. The soft wipe system may be accessible using any type of computing device, for example, personal computer, laptop computer, smartphone, tablet, smartwatch, head-mounted display, smart television or other smart appliance, augmented reality device, virtual reality device, and/or the like.

Thus, the soft wipe system may be accessible locally using a computing device where the soft wipe system is installed and/or may be accessible remotely through another computing device. For example, the soft wipe system may be accessed by a user using a device that communicates with the soft wipe system to perform soft wipes of data storage devices, to validate soft wipes of data storage devices, and/or the like. However, the soft wipe system may be located and operate on a different information handling device to perform the described steps. In other words, the user may access a device housing the soft wipe system or may access a device that communicates with a device housing the soft wipe system.

The soft wipe system can be provided as a service to other entities or companies. Alternatively, the soft wipe system could be leased to other entities so that the other entities could control the access to or keep control of the data storage devices.

The soft wipe system may include different components for carrying out different functions of the system, including different steps to be performed. These components may be hardware components or software components. Some hardware devices or components that may be utilized by the soft wipe system include input devices that may be utilized to receive input from the user, for example, mechanical input modalities (e.g., keyboard, mouse, etc.), touch input devices, gesture input devices, electromyography input devices, audio input devices, and/or the like. Other hardware components may be utilized to provide output from the soft wipe system. For example, the soft wipe system may include speakers, displays or monitors, haptic output devices, audio output devices, and/or the like. In addition, the storage that participates in the soft wipe system can include any rewritable, persistent data, block addressable unit. For example, the storage may include magnetic tape, rotational magnetic disc, optical disc, non-volatile flash ram, and/or the like.

It should be noted that while a soft wipe system may be discussed herein, different steps may be performed by different components of the soft wipe system, including the data storage device itself. In other words, in some cases or applications, the data storage device itself may perform some of the functions and steps described as opposed to a separate system or separate component of the soft wipe system. Thus, the soft wipe system could simply be the data storage device itself and no other components. However, the soft wipe system could include other components.

At 301, a data storage device may receive an input instructing that data on the data storage device is to be made inaccessible. For ease of readability, the process for making the data on the data storage device inaccessible will be referred to as a soft wipe. The input may be received from a user who wants to make the data on the data storage device inaccessible. Receipt of the input may be receipt of a manual input or any other indication that is set to trigger or initiate the soft wipe. Some examples of inputs may include, but are not limited to, a user providing input to an icon that initiates the soft wipe, a data storage device being connected to a soft wipe system, a data storage device being selected for a soft wipe within an application of the soft wipe system, a particular user accessing the data storage device with particular credentials, and/or the like. Thus, the input can be a specific input that is set to initiate the soft wipe system or may be an inferred input, for example, the connection of the data storage device to the soft wipe system. The inputs that can used to initiate the soft wipe can be set by a user or entity, be default settings, learned by the system over time, and/or the like.

In order to prevent unauthorized users from initiating a soft wipe on a data storage device, the system may be set with safeguards. One safeguard may be a requirement to provide a key to initiate the soft wipe of a data storage device. The key may correspond to a previous initialization of the data storage device. When an initialization is performed of the data storage device, part of the initialization may be to create a key, which could be an encryption key, random character (e.g., numbers, letters, symbols, etc.) string, character string generated based upon some seed value, and/or the like. Once the initialization is complete, the key may be presented to the user. The user may then store the key for use with the next initialization.

Upon initiating a subsequent initialization, the key may need to be provided. Upon receipt of the key, the soft wipe system, which may include the data storage device, may validate the key. Thus, when generating the key, the soft wipe system may store the key within a data repository that can be accessed later. The data repository may be a component of the soft wipe system or may be a data storage location within the data storage device. Upon receipt of the key, the soft wipe system may compare the received key with the stored key to determine if a match has been received. Depending on the type of key, the comparison may include simply a comparison or may include performing other steps to derive the key for comparison. For example, if an encryption key is utilized, the system may need to perform steps to decrypt the key so that it can be compared. Additionally, if an encryption key is utilized, other information may need to be stored by the soft wipe system, for example, a private key of the soft wipe system or data storage device.

If the key is not validated, meaning there is no match between the key provided and the stored key, the soft wipe system may provide a notification to the user that the key does not match and no initialization will be performed. The user may be allowed more than one attempt to provide the correct key. Upon a predetermined number of unsuccessful attempts, the user may be locked out of the data storage device or soft wipe system so that the user can no longer attempt to initialize the data storage device. The predetermined number of unsuccessful attempts may be set by a user or entity, may be a default value, and/or the like. Additionally, the soft wipe system or data storage device may have settings that allow for additional attempts after a predetermined trigger has been received, for example, expiration of a time period, provision of additional credentials, and/or the like.

If the key is validated and an initialization is performed, a new, different key will be generated and provided after the initialization. Thus, the system, upon receiving the input to initiate the soft wipe on the data storage device, may request a key corresponding to a previous initialization of the data storage device. Until the key is received and verified, the soft wipe system may not perform the initialization. Previously used keys may be stored on the soft wipe system or data storage device. In addition to the keys, other information may be stored, for example, information related to a user who performed the initialization, information related the initialization (e.g., when it was performed, where it was performed, how long it took, any metadata created during the initialization, etc.), and/or the like. The key and other information may be bundled into a packet that can be stored on the data storage device or soft wipe system. A user can then access this information, for example, through the provision of credentials having that authority, through the provision of the key, and/or the like, to display that information. This allows a user to verify or validate one or more previous initializations or simply to look at the information associated with a previous initialization.

It should be noted that an initialization may not only correspond to an initialization that occurs after data is written to the data storage location, but it may also refer to the initial initialization that occurs as the data storage device is manufactured. A freshly manufactured device could have the same initialization as after a soft wipe. Since the data storage device is brand new upon manufacture, the initialization at the time of manufacture may or may not include the initialization of the SMART as is discussed further herein. Rather, the initialization of the SMART at the time of manufacture may simply be an empty SMART or, stated differently, the sector mappings of the SMART may be blank. However, even in the case of a blank SMART, the key can still be generated and provided to the user to be provided along with the data storage device to a purchasing entity or other entity who is going to use and maintain the data storage device or an entity who may perform subsequent initializations.

Another safeguard that may be employed is a request for provision of information related to the user providing the input. The request for the provision of the information may be at the time the input is received, meaning the user has to provide the information in addition to providing the input, or may be provided after the input is received, meaning the user has already provided the input to initiate the soft wipe and is then prompted to provide or input the information. The information may include information that identifies the user and/or information about the initialization. Examples of such information include, but are not limited to, a name or identifier of a user providing the input and requesting the soft wipe, a location of the data storage device when the input has been received, a time of receipt of the input, a length of time to complete the soft wipe, and/or the like. This information may be bundled into a packet that is stored in a data storage location either on the soft file system or the data storage device, for example, in firmware, that will not be deleted or obfuscated during the soft wipe. This packet can be accessed at a later time by an entity to learn more about the soft wipe that was performed. In other words, in response to receiving a query for the information related to the user or previous soft wipe, the system may retrieve the packet and provide the information within the packet in response to the query.

It should be noted that other safeguards may be implemented to ensure that only authorized users are able to initiate an initialization of the data storage device. Additionally, a combination of safeguards may be employed. For example, to initiate an initialization, the soft wipe system or data storage device may request a previously generated key and may also request information related to the user before an initialization will be started.

At 302, the soft wipe system may determine if the user who provided the input at 301 is authorized to perform or initialize the soft wipe. The information that may be provided at 301 may also be useful for validating the initialization or ensuring the user providing the input is authorized to perform the initialization. Thus, the information may include authentication information (e.g., credentials, biometric information, information associated with a role of the user, etc.) that can be used to not only authenticate and verify the user, but may also be used to verify that the user has the authority to perform the soft wipe of the data storage device. The authority to perform the soft wipe may be provided to a certain group of users, a particular role or roles of a user, and/or the like. Thus, the authentication information may be utilized to ensure that the user is someone who corresponds to that group of users, has that role, and/or the like.

In some cases, the credential information may be enough to ensure the user has the authority. The system may include a list of users or roles of users that are authorized to perform soft wipes. This list may be different for different data storage devices, different data storage device types, different departments that have data storage devices, and/or the like. Thus, a user who has the authority to perform a soft wipe on one data storage device may not have the authority to perform a soft wipe on a different data storage device. Once the user credentials are provided to the system, the system may compare the user associated with the credentials or the credentials themselves to the list. If the user is on the list, then the system determines the user has the authority to perform the initialization (yes from 302). If the user is not on the list, then the system determines that the user does not have the authority to perform the initialization (no from 302). Alternatively, the credential information may simply be used to authenticate the user into the soft wipe system, but may not be enough information to allow the user to perform the soft wipe of the data storage device.

Thus, alternatively, or additionally, the user may have to input information in addition to the credentials in order for the system to determine if the user has the authority to perform the initialization. For example, after authenticating the user into the soft wipe system, the user may have to provide information identifying or indicating an authority to perform the soft wipe. One type of information may include the user having to provide role or title information to the system, which can be verified by the system against roles or titles that are authorized to perform the initialization. Another type of information may include the user having to provide information related to another user who has provided the authority to perform the initialization. For example, the user may have to identify a manager, entity who is assigned to the data storage device, and/or other authority that has indicated the soft wipe should be performed. The system may then notify the indicated authority that the user is attempting to perform a soft wipe of the data storage device and may request that the authority confirm that the user is authorized to perform the soft wipe.

Another type of information may include the user having to provide an authorization key or code in order to access a part of the soft file system that allows for the start of the initialization. This authorization key or code would be different than the key required by the data storage device. Other information or techniques for determining if the user has the authority to perform the soft wipe are contemplated and possible. Additionally, a combination of information or techniques may be utilized.

If it is determined that the user does not have the authority to perform the initialization at 302 (no from 302), the soft file system may take no action at 304. Taking no action may include not performing the soft wipe of the data storage device. Taking no action may also include providing a notification to the user providing the input that the soft wipe will not be performed because the user does not have the authority to perform the soft wipe. The notification may also detail why the authority of the user was unable to be verified, for example, because the user cannot perform soft wipes of that particular data storage device type, because the credential information or other authentication information was incorrect, and/or the like. The system may also send a notification to another user indicating that a user was trying to perform a soft wipe without having the authority to do so. Depending on the reason that the authority was unable to be verified, the user may also be able to attempt to provide the information again. The actions, including a combination of actions, that are taken by the system in response to determining that the user does not have the authority to perform the soft wipe may be set by a user or entity, may be default actions, and/or the like.

If, on the other hand, it is determined that the user does have the authority to perform the initialization at 302 (yes from 302), the soft file system may initiate the soft wipe on the data storage device at 303. To initiate the soft wipe, the sector mapping and relocation table (SMART) on the data storage device may be initialized. In initializing the SMART, all sectors of the table will be mapped to fake data. A SMART is a mechanism in the firmware of a data storage device that redirects any read requests to a damaged portion of the data storage device to another portion of the data storage device that contains the information and that is not damaged. In other words, a SMART is a redirection mechanism for read requests. It ensures that if any sectors of the data storage device are damaged or otherwise unreadable, the read request is directed to the new, readable location where the requested data has been stored. When the SMART is first initialized, all the sectors are empty. As portions of the data storage device are made unreadable, sectors of the SMART are written with the instructions for finding the new, readable location of the data. Thus, when a read request is provided requesting that data, the read request is sent to the SMART, which then directs the read request to the new, readable location.

In the described soft wipe, instead of initializing the SMART to have all empty sectors, the SMART is initialized so that all the sectors return fake data. The SMART table entries may be written with pointers to the fake data. The SMART table entries may contain only indicators to return fake data for given entries. Thus, the fake data can be created or populated and stored within the SMART using one or more techniques. Some example techniques for the creation or population and storage of the fake data will be described herein. However, these are merely examples and are not intended to be limiting, as other techniques for creating or populating and storing the fake data are contemplated and possible. Storage of the fake data with respect to the SMART may either be done within the normal storage part of the device, separate storage, volatile or non-volatile flash memory, and/or the like.

With respect to the storage of the fake data, the fake data could be stored within non-volatile ram accessible to the SMART, could be created at device start and stored in volatile memory accessible to the SMART, could be stored within a normally addressable storage portion of the device, could be stored within a storage location not normally addressable from outside the device, could be created upon receipt of a read request, could be a return of an uninitialized storage record, and/or the like. One way to populate the fake data is to generate the fake data on the fly upon receipt of the read request. When generating fake data this way, random data could be generated. Thus, the data storage device may have a mechanism that causes random data to be generated when a read request is received. For example, the storage device could be populated with a random data generator that generates random data upon access to specific sectors through the SMART. Another technique for populating the fake data is to include a pointer in the sector of the SMART to a trash location of the data storage device. Thus, in this case the data is real data, but it is data from a trash location so it does not provide any useful data to someone who is requesting data.

The fake data may be insignificant or it might be made meaningful. This may mean that the initialized SMART sectors are populated with random characters (e.g., numbers, letters, symbols, etc.), the same characters (e.g., all 1s, all 0s, all As, etc.), a message (e.g., “This is fake data”, “This device has been soft wiped”, etc.), and/or the like. The fake data may also be populated in a data storage location and the SMART may be populated with pointers to the data storage location. For example, a data storage location on the data storage device may include an eyecatcher indicating fake data and this is returned through the SMART mechanism. As another example, a data storage location on the data storage device may include any of the data previously mentioned and when it is returned, the SMART logic adds an address identifier or eyecatcher into the returned data. Other techniques for populating fake data are contemplated and possible. Additionally, combinations of populating the fake data are possible. For example, the fake data can include, but is not limited to, blank data, arbitrary data, randomly generated data, data comprising a predetermined message, data based on characteristics of the request, data written to the data storage device, and data present within device memory, data from a trash location on the data storage device, on-the-fly generated data, and/or the like.

When performing the initializing, other steps may also be performed in addition to the population of the fake data and setting the sectors of the SMART to the fake data. For example, in the case that keys are needed to perform the initialization, when the data storage device is initialized a new key may be generated and provided to the user who provided the input. This key can then be to perform subsequent soft wipes of the data storage device. As another example, in the case that information related to the user and/or initialization is captured, the packet with this information may be created and stored. In some cases, packets may be overwritten, meaning that only a single packet will be stored on the data storage device at a time. In other cases, all previously generated packets will be stored and new packets will be added to the data storage location that includes the packets.

Once the SMART has been initialized, when a read request is received, the response to the read request will be the fake data. In other words, subsequent to the initializing, when a read request to a sector of the data storage device is received, the data storage device accesses the SMART and returns the fake data associated with the sector in the SMART. Subsequent to the initializing, when a write request of real data onto the data storage device is received, the data storage device will overwrite a sector on the storage device that corresponds to the write request with the real data and update the SMART to point to that sector’s location. Then, when a read request to the sector having the real data is received, the data storage device will access the SMART and return the real data associated with the sector. The SMART will also function as normal with respect to redirecting read requests to damaged sectors. In other words, if a sector is damaged or unreadable, the SMART will update so as to redirect a read request to the damaged or unreadable sector to a new, undamaged or readable sector. Thus, such a system makes it impossible to read data that was written to the data storage location before the initialization, but still allows the data storage device to function as it normally would.

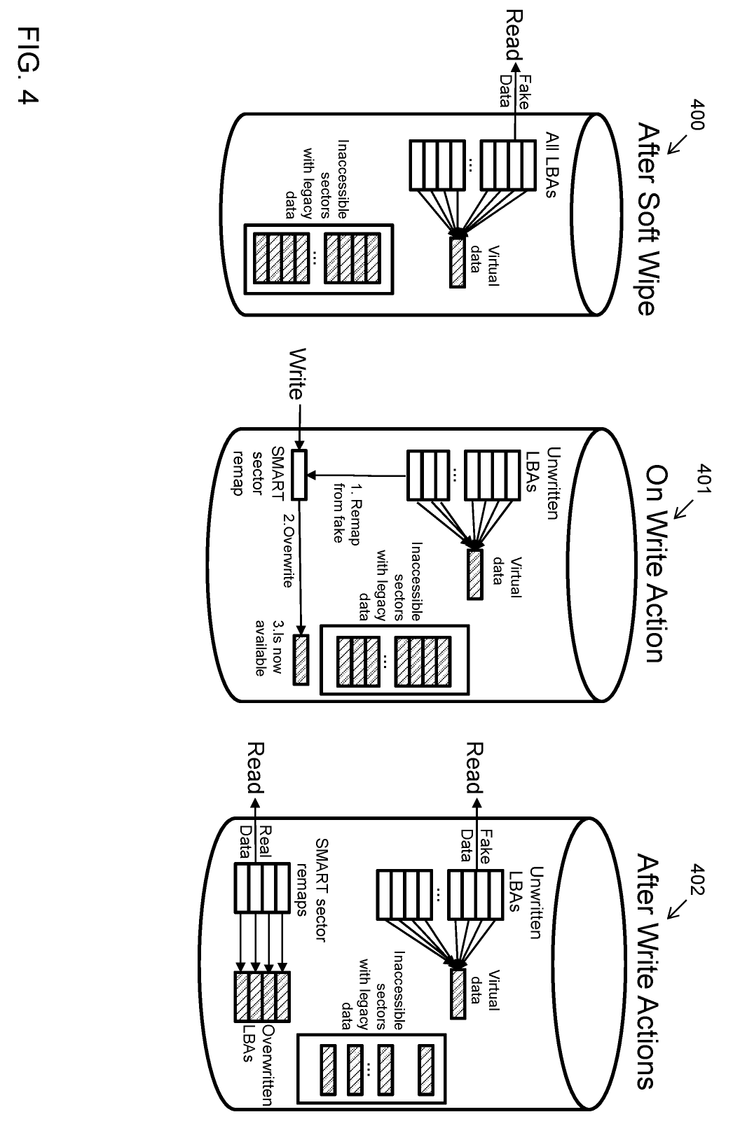

FIG. 4 illustrates a pictorial representation of a data storage device after a soft wipe 400, on a write action after the soft wipe 401, and after the write action after the soft wipe 402. As illustrated at 400, any read requests return fake data. When real data is written to the data storage device 401, the corresponding sector in the SMART is remapped from the fake data to a sector of the data storage device that the real data has been written to. After the real data is written 402, if a read request is received that corresponds to a sector that does not have real data that was written subsequent to the soft wipe, fake data will be returned. If, on the other hand, if a read request is received that corresponds to a sector that has real data that was written subsequent to the soft wipe, the real data will be returned.

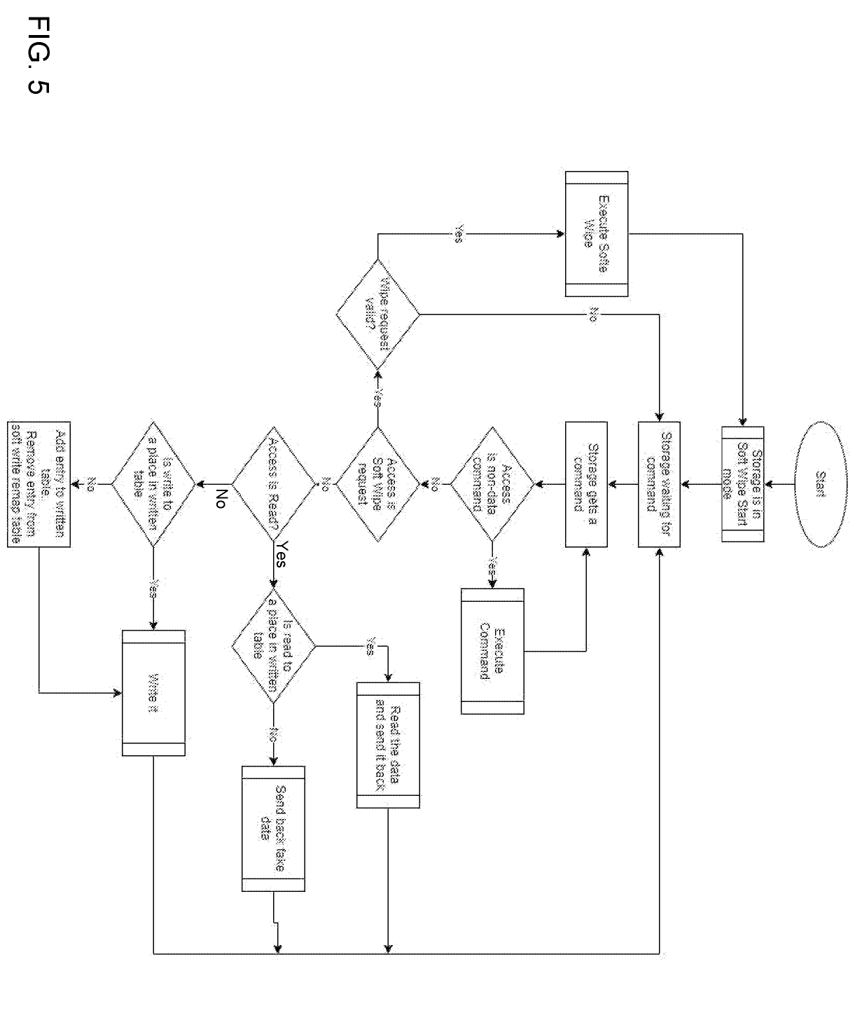

FIG. 5 illustrates a flow chart of executing a soft wipe and the process for reading data after a soft wipe. The storage is in a soft wipe start mode and is waiting for a command. When the storage gets a command, if the access is a non-data command, the system executes the command and then waits for the next command. If, on the other hand, the access is not a non-data command, the system determines if access to a soft wipe is being requested. If the access is a soft wipe request, the system determines if the soft wipe request is valid. If the soft wipe request is not valid, the storage returns to waiting of a command. If, on the other hand, the soft wipe request is valid, the system executes the soft wipe.

If the access is not a soft wipe request, the system determines if the access is a read request. If the access is a read request, the system determines if the read request is to a place written in the SMART, where a write occurred after the soft wipe. The determination of a previous write can be done in many ways, including, but not limited to the following examples. As one example, the initialization could set all SMART entries to a specific value to indicate to return fake data. In another example, the device could maintain two lists, one for unwritten data and one for written data and return fake data for any sector not written. In another example, the device could maintain one list of written data that grows as sectors are written and return fake data for any entry not in the list. In another example, the initialization could set all SMART entries to various out-of-bounds index values that indicate what kind of fake data to return. In another example, spare bits in the SMART remapping index could be dedicated to indicate whether the data at the location is real or fake. In another example, the SMART could be extended to include a separate flag that indicates whether each sector has been written. In another example, there might be no direct indicator of a previous write but the unwritten SMART entries all point to a fake data sector in the storage. If the read is to a place that has been written in the SMART after the soft wipe, the system reads the data and sends it back in response to the command. If the read is to a place that has not been written after the soft wipe, the system sends back fake data in response to the command.

If the access is not a read request, the system determines if the access is a write request to a place in the SMART or written table. If the access is a write request to a place that has not been written in the SMART, the system marks the place as written. Then the system writes the entry. If the access is a write request to a place that is in the written table, the system writes the data. After writing the data, the system waits for the next command.

It will be readily understood that the components of the embodiments, as generally described and illustrated in the figures herein, may be arranged and designed in a wide variety of different configurations in addition to the described example embodiments. Thus, the more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

As will be appreciated by one skilled in the art, various aspects may be embodied as a system, method, or device program product. Accordingly, aspects may take the form of an entirely hardware embodiment or an embodiment including software that may all generally be referred to herein as a “circuit,” “module” or “system.” Furthermore, aspects may take the form of a device program product embodied in one or more device readable medium(s) having device readable program code embodied therewith.

It should be noted that the various functions described herein may be implemented using instructions stored on a device readable storage medium such as a non-signal storage device that are executed by a processor. A storage device may be, for example, an electronic, magnetic, optical, electromagnetic, infrared, or semiconductor system, apparatus, or device, or any suitable combination of the foregoing. More specific examples of a storage medium would include the following: a portable computer diskette, a hard disk, a random-access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a storage device is not a signal and is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire. Additionally, the term “non-transitory” includes all media except signal media.

Program code embodied on a storage medium may be transmitted using any appropriate medium, including but not limited to wireless, wireline, optical fiber cable, radio frequency, et cetera, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of connection or network, including a local area network (LAN) or a wide area network (WAN), or the connection may be made through other devices (for example, through the Internet using an Internet Service Provider), through wireless connections, e.g., near-field communication, or through a hard wire connection, such as over a USB connection.

Example embodiments are described herein with reference to the figures, which illustrate example methods, devices, and program products according to various example embodiments. It will be understood that the actions and functionality may be implemented at least in part by program instructions. These program instructions may be provided to a processor of a device, a special purpose information handling device, or other programmable data processing device to produce a machine, such that the instructions, which execute via a processor of the device implement the functions/acts specified.

It is worth noting that while specific blocks are used in the figures, and a particular ordering of blocks has been illustrated, these are non-limiting examples. In certain contexts, two or more blocks may be combined, a block may be split into two or more blocks, or certain blocks may be re-ordered or re-organized as appropriate, as the explicit illustrated examples are used only for descriptive purposes and are not to be construed as limiting.

As used herein, the singular “a” and “an” may be construed as including the plural “one or more” unless clearly indicated otherwise.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected therein by one skilled in the art without departing from the scope or spirit of the disclosure.

What is claimed is:

1. A method, the method comprising:
receiving, at a data storage device, an input instructing that data on the data storage device is to be made inaccessible; and
initializing, on the data storage device, a sector mapping and relocation table, wherein the initializing comprises mapping all sectors of the sector mapping and relocation table to fake data.

2. The method of claim 1, comprising requesting, responsive to the receiving of the input, a key corresponding to a previous initialization and wherein the initializing is responsive to receipt and authentication of the key.

3. The method of claim 2, wherein the initializing comprises generating a new key corresponding to the initializing and providing the new key to a user providing the input.

4. The method of claim 1, wherein the receiving of the input comprises receiving information related to a user providing the input and wherein the initializing comprises storing the information related to a user within a packet in firmware of the data storage device.

5. The method of claim 4, comprising receiving a query for the information related to the user, retrieving the packet, and providing the information in response to the query.

6. The method of claim 1, comprising receiving, subsequent to the initializing, a read request to a sector of the data storage device and accessing and returning the fake data associated with the sector.

7. The method of claim 6, wherein generating the fake data comprises generating random data responsive to receiving the read request.

8. The method of claim 1, comprising receiving a write request of real data onto the data storage device and overwriting a sector of the data storage device and updating the sector mapping and relocation table that corresponds to the write request with the real data location.

9. The method of claim 8, comprising receiving, subsequent to the writing, a read request to the sector having real data and accessing and returning the real data associated with the sector.

10. The method of claim 1, wherein the fake data comprises at least one data selected from the group consisting of: blank data, arbitrary data, randomly generated data, data comprising a predetermined message, data based on characteristics of the request, data written to the data storage device, and data present within device memory, data from a trash location on the data storage device, and on-the-fly generated data.

11. A system, the system comprising:
a processor;
a memory device that stores instructions that, when executed by the processor, causes the system to:
receive, at a data storage device, an input instructing that data on the data storage device is to be made inaccessible; and
initialize, on the data storage device, a sector mapping and relocation table, wherein the initializing comprises mapping all sectors of the sector mapping and relocation table to fake data.

12. The system of claim 11, comprising requesting, responsive to the receiving of the input, a key corresponding to a previous initialization and wherein the initializing is responsive to receipt and authentication of the key.

13. The system of claim 12, wherein the initializing comprises generating a new key corresponding to the initializing and providing the new key to a user providing the input.

14. The system of claim 11, wherein the receiving of the input comprises receiving information related to a user providing the input and wherein the initializing comprises storing the information related to a user within a packet in firmware of the data storage device.

15. The system of claim 14, comprising receiving a query for the information related to the user, retrieving the packet, and providing the information in response to the query.

16. The system of claim 11, comprising receiving, subsequent to the initializing, a read request to a sector of the data storage device and accessing and returning the fake data associated with the sector.

17. The system of claim 16, wherein generating the fake data comprises generating random data responsive to receiving the read request.

18. The system of claim 11, comprising receiving a write request of real data onto the data storage device and overwriting a sector of the data storage device and updating the sector mapping and relocation table that corresponds to the write request with the real data location.

19. The system of claim 18, comprising receiving, subsequent to the writing, a read request to the sector having real data and accessing and returning the real data associated with the sector.

20. A product, the product comprising:
a computer-readable storage device that stores executable code that, when executed by a processor, causes the product to:
receive, at a data storage device, an input instructing that data on the data storage device is to be made inaccessible; and
initialize, on the data storage device, a sector mapping and relocation table, wherein the initializing comprises mapping all sectors of the sector mapping and relocation table to fake data.
